(19) United States
(12) Patent Application Publication
(10) Pub. No.: US 2012/0095994 A1
(43) Pub. Date: Apr. 19, 2012

(54) Intelligent Search Appliance with Memory and Feedback

(75) Inventor: Nagendra Nagarajayya, Pleasanton, CA (US)

(73) Assignee: TRANSAXTIONS LLC, Pleasanton, CA (US)

(21) Appl. No.: 13/274,334

(22) Filed: Oct. 16, 2011

Related U.S. Application Data
(60) Provisional application No. 61/393,954, filed on Oct. 18, 2010.

(51) Int. Cl. G06F 17/30; G06F 15/16

(52) U.S. Cl. 707/723; 709/209; 707/E17.084

(57) ABSTRACT

A system and method to search accurately and relevantly using the ranking algorithm and the intelligent index, learning context relationships using feedback and memory with social awareness.

### CROSS-REFERENCE TO RELATED APPLICATIONS

This application claims priority of U.S. provisional application Ser. No. 61/393,954, titled “Intelligent Search Appliance with Memory and Feedback” filed Oct. 18, 2010 by the present applicant.

This application is related to U.S. Pat. No. 7,792,811, titled “INTELLIGENT SEARCH WITH GUIDING INFO” filed Dec. 22, 2005 by the present applicant.

This application is related to US Application number 20070226078, titled Guiding Info Tabs With Guide Selection first filed Mar. 6, 2006 by the present applicant.

### FIELD OF THE INVENTION

The present invention relates to search using the intelligent index with memory, feedback and social awareness with a unique ranking algorithm to show the most relevant, socially aware results.

### BACKGROUND OF THE INVENTION

This invention builds on the invention described in patent application U.S. Pat. No. 7,792,811. Cloud, enterprise, homes are now networked socially and there is a need for ranking documents intelligently with social awareness and unsupervised learning, learning from the context of the searches to associate contexts and social awareness. This invention describes a new RankingAlgorithm that is accurate and can rank documents relevantly while also learning the search context, the context relationships with social awareness.

### BRIEF DESCRIPTION OF THE INVENTION

Search is becoming part of everyday lives of computer users, not just on the internet but in the enterprise, retailers, businesses and even households as the number of documents and mail keep increasing. This invention describes an intelligent search appliance that can be deployed in a cloud or within an enterprise or business or home that can search intelligently returning highly accurate and relevant results while also learning the context relationships with social awareness. A plurality of users can share the learning making it a fun social experience.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of an intelligent search system.

FIGS. 2, 3, 4 is an illustration of the output of the RankingAlgorithm.

FIGS. 5, 6, 7, 8, 9, 10, 11 are illustrations of the intelligent index learning a context and associating relationships between contexts.

FIG. 12 is an illustration of a server device and a search component, wherein the search component is SoIr, an open source search platform, using the RankingAlgorithm.

FIG. 13 is an illustration showing the score as a floating point number and encoding relevancy.

FIGS. 14, 15 is an illustration of a socially aware search.

### REFERENCES CITED

### U.S. PUBLISHED APPLICATIONS

### OTHER REFERENCES

### PARENTS CASE TEXT

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

A number of terms are used herein to describe features of embodiments of the present invention.

As used herein, the term “search” will be used to refer to a request made up of query terms sent in from a client device to a server device. The server device processes the request and sends back the most relevant results related to the query terms.

As used herein, the phrase “computer system” is usually made up of a processor, memory, storage, network, clock, input devices and output devices. Input devices can be a keyboard, a pointer device such as a mouse, touch screen, [etc.]. Output devices usually are display, printers, plotters, and controllers, [etc.]. The brain of a computer system is usually the processor such as a microprocessor. A microprocessor executes machine level instructions that enable it to perform logic as well as communicate with the input and output devices. The machine level instructions can be executed with dedicated electronic circuits or use a higher level programmable code that enables the microprocessor to execute a task. The computer system usually at startup, loads an operating system (OS) that manages the input and output devices and also enables executing higher level applications. A server device is a computer based system that usually responds to a client device request. The server device executes a server application that can listen to client requests and respond back with a response. A client device is again a computer based system that communicates across a network 140 with a server device for content. The client device can be a thin client or a thick client. In a thin client, the client device does not handle much processing other than collect input send it across to the server for processing and output the response from the server onto the output devices on the client, like a display, [etc.]. In a thick client, the client device might run an operating system itself, do more processing and communicate with the server device as needed. The communication is usually handled by higher level applications being executed on the client device which make use of networking means to communicate. In an embodiment, the client device and server device might be a single system communicating across a network.

As used herein, the phrase “client device” 120 will be used to refer to the device used by a user to initiate a search. The phrase “client device” has also been used broadly to refer to client applications executing on the device. The client device can be a general purpose computer system with a processor, storage, network connectivity and a display. The client device usually executes a client application, maybe a browser that can communicate across a network with a server device and retrieve content. The retrieved content is shown on the client display. The browser can also execute program code and such as JavaScript, Java, [etc.].

As used herein, the phrase “server device” 150 may be used to refer to a device that executes a server application waiting to respond to a client request. The phrase “server device” has been broadly used to refer to server applications executing on the server device. On a client request such as a request from a browser or a client application, the server application sends back content that can be shown on the client display. The content can be text, graphics, sound, media streams, etc. A server device might execute a plurality of server applications, and in an embodiment a server application might itself act as a client and make requests to other server applications executing on the server device or other server devices on the network. A server device usually handles concurrent requests from a plurality of client devices. In an embodiment a plurality of server devices may appear as one to a plurality of client devices to handle the incoming client requests and to scale in performance.

As used herein, the term “browser” 130 may be used to refer to a client application that usually executes on a client device. A web browser is usually referred to as a browser application that is used to browse content on the internet/intranet from a server device. The content usually is HTML. The browser usually has the capability to show other content. HTML is a tag based language and uses tags to identify content. An HTML document is organized into sections with a “<begin> and “<end>” tag. It begins with a <HTML> tag followed by a <HEAD> tag (section), followed by a <BODY> tag (section). A body tag acts as a container for other tags like <TABLE>, <DIV>, <SPAN>, <P>, <FONT>, [etc.]. The browser renders HTML content onto the display device making use of any Cascading Style Sheets (CSS) usually in the HEAD section to format and style the content rendered. HTML enables a viewer to enjoy print quality visuals on the display. HTML can be associated with JavaScript program code to create rich action oriented applications. A browser is also usually a javaScript interpreter or provides such a functionality to execute javaScript program code associated with HTML. A browser also makes use of the timer functionality on a client device enabling JavaScript program code to be executed at timer intervals. Program code sign up for these timer services using convenience function calls, such as settimer(function, delay), setinterval(function,delay) and clearinterval(id). In an embodiment, the browser might be a client application consuming content from a server device.

As used herein, the term “display” may be used to refer to the display device connected to the client device that allows content to be shown. Display is a piece of electrical equipment usually connected to the video source of the client device. The display can show text, graphics, generate sound, and maybe linked to/show sensory outputs, [etc.]. Display devices usually are (Liquid Crystal Display) LCD based but can be (Cathode Ray Tube) CRT, Plasma or Light Emitting Diode based, [etc.]. Display devices can be part of the client device as in a laptop or separated from the client device as in a general purpose computer. The display device may also be haptic enabled or connected to haptic input/output devices.

As used herein, the phrase “haptic or tactile devices” may be used to refer to the sensory devices enabling sensory content to be displayed or input. Sensory content can be text, graphics, sound mixed with signals to control changing the intensity of vibrations, color, smell/aroma, touch, feel, thermal, location, movement, force, etc.

As used herein, the phrase “ranking algorithm” may be used to refer to an algorithm that can be used to score documents and rank them based on the terms found in the document.

The scoring is a follows:

Step 1. Maximum score when all terms are found across the document. If only some terms match, subtract from baseline (maybe 100), number of matching terms.

Step 2. If they are next to each other they get a very high score, A

Step 3. If they are closer to the start of the doc, a high score, A (note: this score keeps track of occurrence of the term, so lower the value better)

Step 4. If they are located across the document but with other words in between they still get a high score B but lower than the highest score, A. If the distance between the terms is greater than the number of terms, score lower than C.

Step 5. If the terms are located multiple times in the same order, freq count is incremented. If they are located close to each other but with the terms reversed they still get a high score C that is a lower score than B

Step 6. If they are located across the document but with terms mixed they still get a score D that is lower than score C.

Step 7. If only some of the terms exist, then they get a lower score than D

Step 8. If term repeats, freq count is incremented

Step 9. If the terms occur next to each other multiple times/reversed/mixed, they get a high score A/B/C/D and freq count of repetition is incremented

### EXAMPLE 1

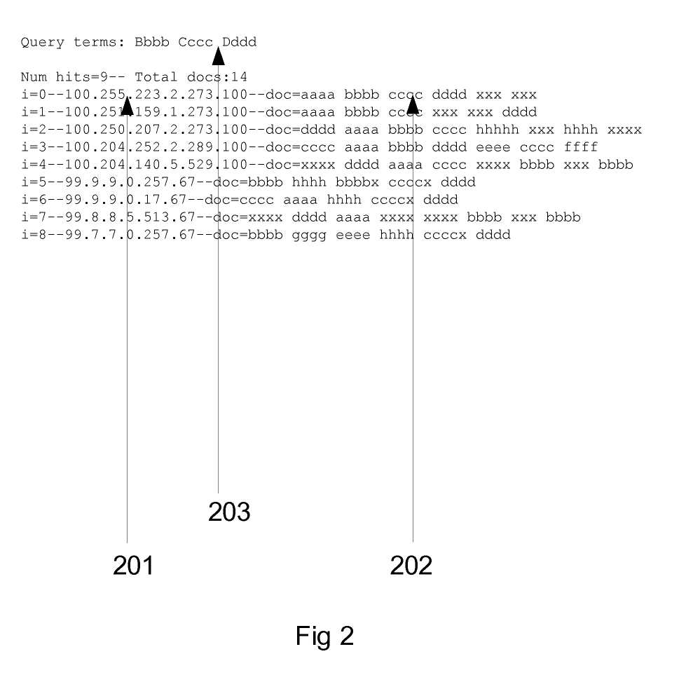

If the query terms are B C D (FIG. 2: 203), and there is just one document in the index containing the terms, A B C D E F G (FIG. 2: 202), the scoring will be as below:

Step 1. Since all terms exist in the document

Score=100

Step 2/4/6/7. Find the closest occurrence of terms and calculate the difference in occurrence to each other:

C−B=1 (15)

D−C=1 (15)

Normalize 1 as highest. For eg. Use 4 bits to store each occurrence difference, so if C−B=1 shift bits by 4 positions, and normalize to highest value, value=15, if difference is −1, score=14, and so on . . . (lowest value is 1). , D−C=1, so shift bits again by 4 position and normalize to highest value, since difference is 1, value=15. If abs(term A−term B) has a difference>1, then if difference<=2, value=13, and if difference <=−2, difference=12, and so on

Score=1111 1111

Score=255

Step 5/6/7. Find difference in occurrence of terms to the first term:

D−B=4−2=2 (13)

C−B=3−2=1 (15)

Normalize 1 as highest. For eg. Use 4 bits to store each occurrence difference, so if D−B=2, change bits to value 13, C−B=1, so shift bits by 4 positions, and normalize to highest value, if difference is 1, value=15, if difference is −1, score=14, and so on . . . (lowest value is 1). If abs(term A−term B) has a difference>1, then if difference<=2, value=13, and if difference<=−2, difference=12, and so on until difference>7=0. The normalization is just one of the ways to store the occurrence info and in other embodiments could be done differently including adding a condition that if the difference is>number of terms, value=0.

Score=1101 1111

Score=223

Step 3. First position of B occurrence in the document is 2.

Score=2

Step 8. Frequency of B is 1, C is 1 and D is 1, shift bits by 4, and store the freq of second term, shift bits by 4 and store freq of bits.

Score=0001 0001 0001 in binary

Score=273 in decimal

Step 9. The terms B C D occur in the document next to each other is 1

Score=100

Freq score=1

Total Score:

100.255.223.2.273.100.1 (FIG. 2: 201)

### EXAMPLE 2

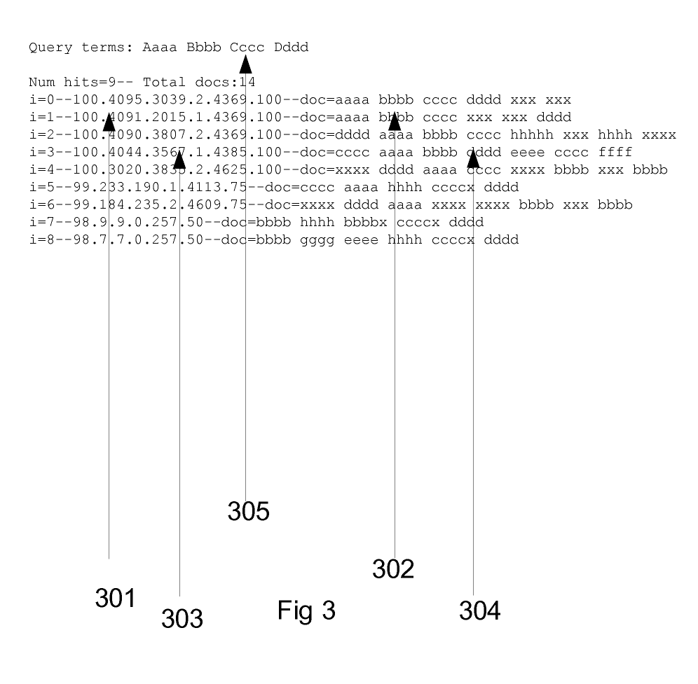

Query Terms: A B C D (FIG. 3: 305)

One document with below words:

A B C X X D (FIG. 3: 302)

Step 1.

Score=100

Step 2/4/6/7

ABCXXD

B−A=2−1=1 (15)

C−B=3−2=1 (15)

D−C=6−3=3 (11)

Score=1111 1111 1011

Score=4093

Step 5/6/7.

D−A=6−1=5 (7)

C−A=3−1=2 (13)

B−A=2−1=1 (15)

Score=0111 1101 1111

Score=2015

Step 3.

Score=1

Step 8.

A=1,B=1,C=1,D=1

Freq=0001 0001 0001 0001

Score=4369

Step 9.

Score=98 (the terms are in the right order but have other terms between them)

Freq score=1

Total score=100. 4093. 223.1.4369.98.1 (FIG. 3: 301)

### EXAMPLE 3

Terms: ABCD (FIG. 3: 305)

Document: X D A B C X (FIG. 3: 304)

Step 1. 100

Step 2/4/6/7.

B−A=4−3=1 (15)

C−B=5−4=1 (15)

D−C=2−5=−3 (10)

Score=1111 1111 1010

Score=4090

Step 5/6/7.

D−A=2−3=−1 (14)

C−A=5−3=2 (13)

B−A=4−3=1 (15)

Score=1110 1101 1111

Score=3807

Step 3.

Score=3

Step 8.

A=1, B=1, C=1, D=1

Score 0001 0001 0001 0001

Score=4369

Step 9.

Score=99 (since term are in order except for 1 term which is reversed)

Freq score=1

Total score=100.4090.3807.3.4369.99.1 (FIG. 3: 303)

### EXAMPLE 4

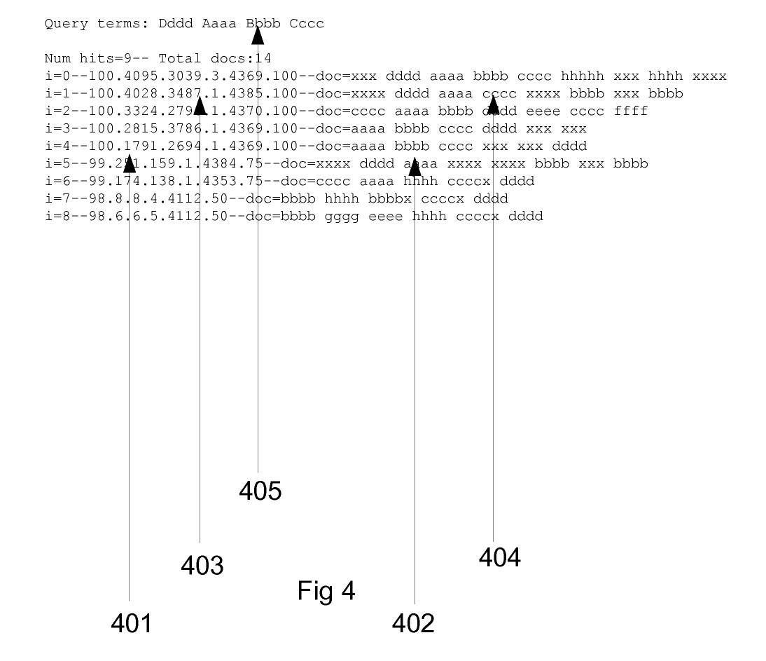

Terms: D A C B (FIG. 4: 405)

Document: X D A X X BX B (FIG. 4: 402)

Step 1.

Score=99

Step 2/4/6/7.

A−D=3−2=1 (15)

C−D does not exist (0)

B−A=6−3=3 (11)

Score=1111 1011

Score=251

Step 5/67.

B−D=6−2=4 (9)

C−D does not exist so (0)

A−D=3−2=1 (15)

Score=1001 1111

Score=159

Step 3.

Score=2

Step 8.

D=1, A=1, C=0, B=2

Score=0001 0001 0000 0010

Score=4354

Step 9.

Score=93 (since one term is missing, only 3 term are found, terms are in order but not next to each other for 1 term which is 2 terms away)

Freq score=1

Total score=99.251.159.2.4354.93.1 (FIG. 3: 401)

### EXAMPLE 5

Terms: D A C B (FIG. 4: 405)

Document: X D A C X B X B (FIG. 4: 404)

Step 1.

Score=100

Step 2/4/6/7.

A−D=3−2=1 (15)

C−A=4−3=1 (15)

B−C=6−4=2 (13)

Score=1111 1111 1101

Score=4093

Step 5/6/7.

B−D=6−2=4 (9)

C−D=4−2=2 (13)

A−D=3−2=1 (15)

Score=1001 1101 1111

Score=2527

Step 3.

Score=2

Step 8.

D=1, A=1, C=1, B=2

Score=0001 0001 0001 0010

Score=4370

Step 9.

Score=98 (since term are in order but not next to each other for 1 term which is 2 terms away)

Freq score=1

Total score=100.4093.2527.2.4370.98.1 (FIG. 4: 403)

In other embodiments, the algorithm may generate a single score that can be represented as a floating point number 1301. The score can also be normalized such that the number of terms matching can be encoded into the score. For eg. a search for “aaaa bbbb cccc” 1302, documents that match all the terms will have scores starting at 300 where the 300 represents the 3 terms matched (num of terms×100) followed by the decimal part as 300.xxx 1301, documents that match two terms will have scores starting with 200.xxx and documents that match a single term will have scores starting with 100.xxx, 1303. In other embodiments, some of the components like the freq component of the score can be ignored to positionally score the term occurrences. In an another embodiment, the distance of the terms from the beginning of the document can be used to compute the components scores ignoring the positional difference between the terms. Other scoring factors that can influence the score positively or negatively can also be introduced. For eg. to check if the title of a documents matches the terms or in the case of an html document, meta tags like title tag matching the terms or keywords tag including the terms, etc. The granularity of scoring in Step 2 can also be increased in an embodiment to increase accuracy. The scoring order Steps can be changed in an embodiment for particular type of documents so as to rank relevantly. Step 3 in this embodiment scores the occurrence of the first term only but in other embodiments, the remaining terms and their occurrence can be included in the scoring.

As used herein, the phrase “relevant results” maybe text, graphics with sound, media streams, haptic/tactile streams, etc. Relevant results may also be accompanied with guiding info and feedback inputs/outputs.

As used herein, the phrase “query” or “query terms” refers to parameters passed from the client device to the server device as part of a search request. Query terms can be keywords or sentence or terms of a search such as city, state, country, adults, children, product, hotel, airfare, vacation, cruise, [etc.] The query term enables the server device to search through the intelligent index to return relevant results.

As used herein, the phrase “intelligent index” refers to using multiple indexes like a known, a semantic and an unknown index as in U.S. Pat. No. 7,792,811 to return relevant results. In an embodiment, the intelligent index can learn the relationship between two terms. For eg. Assuming there is feedback for credit and finance, and credit and finance are also known terms i.e. They exist in the known index or can be looked up in a knowledge base like Wikipedia as a title topic, a query for terms “credit financing”, will pull in search results for terms “credit financing as well as the feedback for credit and financing. If the user finds the result for the credit more relevant and provides more input by selecting and clicking on it, then “credit financing” context can be added with feedback to the unknown index, with “credit” as the parent context, while sub context, financing can be added as a context and related to credit financing. Next as a user makes a search for “credit financing loans”, the feedback for the context “credit financing” will be also be pulled up along with the search results for “credit financing loans”. If the user finds the feedback result more relevant and provides feedback input again by selecting the link, the context “credit financing loans” can now be linked to sub contexts, “financing” and “loans” as a related context and “credit” as the parent context. A further search by the same or another user for the terms “mortgage loans” will now pull up the feedback for “credit financing loans” and if the user now provides input by selecting the feedback result as relevant, the context “mortgage loans” can now be added to the unknown index as related to parent context “credit”. The sub contexts, “mortgage” and “loans” can also be added as related to the context “mortgage loans”. A search for the term “mortgage” will now pull the feedback for the “mortgage” context with the parent “credit” context and related to “mortgage loans” context. So the index has now the ability to associate and learn relations between “mortgage” and “credit”, “finance” and “loans”. In an embodiment, the determination to add a sub context or a compound context to the unknown index is made by passing the terms through a sense analyzer and then looking up the sense tagged terms, maybe throwing away adjectives, etc. and looking up the tagged terms in the known index or a knowledgebase. The intelligent index can also add feedback to the user that the context or sub contexts are known by adding an indicator to the returned results and in parallel make available the search results for the known contexts in separate tabs or similar. The indicators can be color coded as in guiding info tabs for easy association in an embodiment. The indicators serve as visual feedback to the user to associate a context with knowledge.

As used herein, the phrase “feedback” will be used to refer to input or output provided by a user or to a user with an input device such as a keyboard, pointing device or haptic/tactile device or an output device such as display or haptic/tactile device, etc. Input in an embodiment may be click on a link using the pointing device or the keyboard device. Output in an embodiment may be as simple as an indicator to signal importance or relevance of an item.

As used herein, the phrase “memory” will be used to refer storing the feedback from a user in a persistent store and being able to retrieve the feedback from the persistent store.

As used herein, the phrase “guiding info” will be used to refer to Guiding Information, an expert engine that provides information about a category and sub categories. The Information makes it easier to choose a product and also increase ones knowledge about it. The product could be a consumer product such as Television, e.g. Panasonic Television. The Guiding Information shows information about the category Television, sub category Panasonic Television, and the different models available under Panasonic Television. The Guiding Information also provides the lowest and average prices for these models locally and nationally. Guiding Information can be associated with Guide Selections as in US Patent Application 20070226078 to further make it easier for a user to associate input with expert information enabling knowledgeable feedback. In an embodiment, Guiding info can be a simple as a link to a knowledge base where the user can get more information about a topic or context.

As used herein, the phrase “intelligent” refers to the ability of the system to learn from the feedback, store the feedback in memory, associate the terms stored in memory as a context; associate the context to other similar contexts; weight returned results retrieving feedback from memory for a context or similar contexts; move a context from one index to the other based on thresholds; change query terms based on semantic relations of a context; verify known contexts and add feedback to the user in the form of guiding info, indicators, etc.

As used herein, the phrase “context” refers to the context of the search and can be as simple as the query terms themselves or can be terms that have been changed with the semantic index or terms that have been passed through a sense tagger to get a sense of the term and any compound terms, and may have been passed through a known index to associate known contexts, etc.

A sense tagger is similar to WordNet::SenseRelate::AllWords open source tagger that allows terms to be tagged with a sense known to Wordnet. It finds the sense of each term related to the surrounding terms based on measures as in Wordnet: :Similarity i.e. Term sense disambiguation is the task of assigning a sense to a word based on the context in which it occurs.

WordNet® “is a large lexical database of English, developed under the direction of George A Miller (Emeritus). Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated with the browser. WordNet is also freely and publicly available for download. WordNet's structure makes it a useful tool for computational linguistics and natural language processing”.

As used herein, the phrase “passing through the known index” refers to looking up a term with sense, maybe throwing away an adjective but looking up nouns, verbs, etc. in the known index or a knowledgebase such as a Wikipedia topic title and forming sub contexts or maybe adding new compound contexts such as “mortgage”, “loans” or “mortgage_loans”.

As used herein, the phrase “social network” means connected socially through friendship, skills, jobs, education, etc. into a network.

As used herein, the phrase “social graph” means ones connections, interests, hobbies, activities, consumer behaviors, etc.

As used herein, the phrase “social awareness” means being aware of ones social graph and sentiments/emotions in a social network.

As used herein, the phrase “socially information” means social graph nodes such as friends, family, hobbies, work, interests, behavioral habits, etc.

As used herein, the phrase “socially aware search” means searching with social awareness enabling a user to interact and influence the social graph with memory, feedback and learning. For eg. user A (uid:10134) searches for an “ipad tablet” within a socially aware environment, and clicks on the link to apple.com. The input click as feedback is stored in memory with a weightage. Next if the user B (uid:1001) comes along and searches for android tablet, the ipad tablet link is shown at the bottom or some area of the search results indicating that user A who is a friend of user B has searched on ipad tablet 1402. Ipad tablet gets pulled up since it has weightage and user B is searching for a tablet computer. Seeing that user A who is a good friend of B in the social graph is interested in ipad tablet, user B now clicks on the ipad tablet link instead of the android tablet 1503. User B may also click on the android tablet link but is now influenced by the results of one's social graph. If now user C (uid:1016) comes along and is interested in buying a tablet computer, the feedback from user A and user B are shown in the results since A and B are part of C's social graph 1503, 1502. So user C now gets influenced by the social graph to look at the android tablet and the ipad tablet instead of buying a tablet computer or pc. The intelligent index also learns that a tablet is an ipad, and android is also a tablet, and tablet is related to the computer. The index also learns that it maybe ones birthday so maybe return results to include sentiments/greetings or a influential message that it is your birthday or a friends birthday, don't you want to buy this or present this, etc.

As used herein, the phrase “click” refers to a click or change in state of an input device such as a mouse or a joystick button, etc. in a computer based system.

As used herein, the phrase “link” refers to an URL. URLs are Uniform Resource Locators and are of the form http://login:password@address/context?querystring. Address can be a numeric such as an IP address or a hostname.domainname.com. query string can be of the form “parameter=value”.

As used herein, the phrase “appliance” refers to a server device 150 that has a search component, data storage device, web server or http component, a network component and a small kernel os to boot up the appliance.

As used herein, the phrase “search component” 170 refers to a server application on a server device that can handle a plurality of client requests. A search component can be plurality of instances. The search component can exist within the http component or outside of it and may communicate with the http component through a network means. A search component receives the query terms from client application, looks up the query terms using the ranking algorithm or any other search algorithm in an index residing on a data storage device, generates a score for each document found to match the terms and returns the relevant results back to the client device in an embodiment. In another embodiment, the search component can rearrange or add/delete terms based on the semantic index, look up the terms in the intelligent index, match the query terms to a context in the intelligent index, re-arrange results to weight them with feedback, add any known topics and return the relevant results with feedback such as indicators, guiding, media, haptic streams, etc.

As used herein, the phrase “data storage device” refers to a storage means on a server device that can store an index of terms from a plurality of sources such as documents. The index is usually an inverted index but other index structures could also be stored on the storage device. A data storage device with a higher capacity and performance usually holds a plurality of such indexes.

As used herein, the phrase “web server or http component” 160 refers to a server application on a server device that can accept http protocol requests across a network means usually from a client device. A http component may have a plurality of instances and is usually load balanced across a plurality of server devices. A http component usually sends back text/html, but can send back rich media content to a client device.

As used herein, the phrase “network component” refers to a server application on a server device than can accept socket connects across a network means from a client device using a protocol such as tcp/ip. A network component can have a plurality of instances and accept requests from a plurality of requests. A network component allows client application to communicate with other server applications.

As used herein, the phrase “small kernel os” refers to a server application on a server device that allows it to manage the input/output, memory, cpu and other server applications, start/stop the server device, etc. The kernel provides services such as interrupts, scheduling, timer, logging, etc. The kernel application schedules applications to execute on the server device, managing their input and output and memory requests. A small kernel os is an illustration of a small footprint wherein only the minimal application and services needed by the kernel and an application are included so as to keep the memory/storage footprint small. A footprint is a term used to associate size.

As used herein, the terms “Ajax”, “XmlHttpRequest” refers to the ability of the client application like a browser executing on a client device to communicate with the server device to retrieve content asynchronously. The XmlHttpRequest can be initiated on a clock signal or a count threshold trigger or a click to retrieve content from the server device; said content can be selectively refreshed onto the display device using a tag like <DIV>. Before the availability of XmlHttpRequest, a request by a browser would stop and pause functions until the request was completed. The returned content was updated as a complete HTML page and caused a flicker as well as long waits. XmlHttpRequest and selective refresh of the client display enables rich application experience with just HTML and JavaScript.

As used herein, the terms “xsocket-http”, “reverse Ajax”, “Server push” refers to the ability of the server device to push content asynchronously to a client device. The server device starts the content push based on an initial request for content from the client device and pushes the content on changes or events on the server devices or client devices. Such events on the server side might be timing means like clock signal timers, or a change of state communication from a client device such as a click or input means. Server push eliminates the need for polling the server device for content by the client device using a clock signal. Polling can be expensive in terms of resources used, while asynchronous server push eliminates the cost of these expensive resources.

As used herein, the phrase “website” refers to a server device and a server application 160 on the server device that is able to respond back with content, usually HTML based, but could offer other services like email, cloud computing, ftp, [etc.]. A website usually has a name or an IP address. If it has a name it is registered with a name registry so that it can be discovered by users on the internet. The name is usually of the form http/www.name.XXX., where XXX is a Top Level Domain Name (TLD).

As used herein, the phrase “Object converter” refers to a object converter that allows objects with attributes to be represented as Extended Markup Language (XML) or in JavaScript Object Notation (JSON). XML is a tag language that can be used to describe objects with attributes, schemas, [etc.]. HTML tag language is nothing else but XML and is used to describe content to be shown on a display device. XML can be used to describe a Java or a JavaScript language object. The advantage of using XML to describe a language object is it makes the object portable across operating systems, computer systems, and also allows objects to be sent across networks. jSON is another way of representing objects and represents object attributes as name, value pairs. Object converter provides methods that allow a language object to be converted to XML/JSON, and from JSON/XML back to the language objects.

As used herein, the phrase “user” refers to a user of a client device initiating a search request by inputting query terms and sending the request to the server device.

System

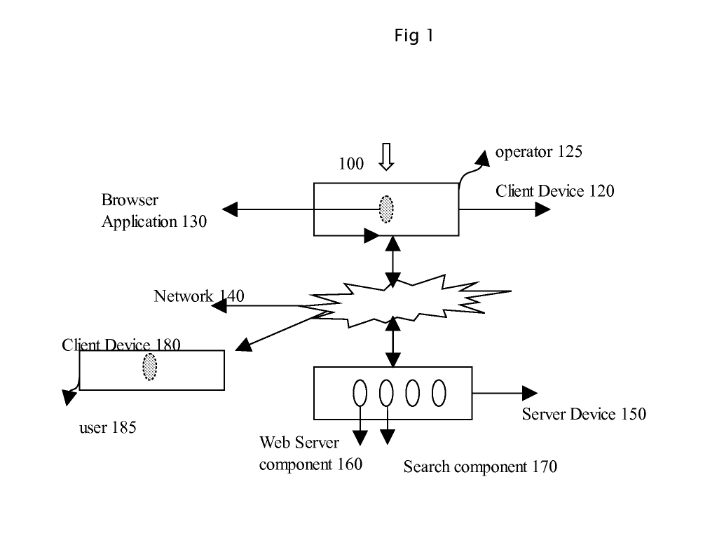

Referring first to FIG. 1, an Intelligent Search Appliance 100 according to embodiments of the present invention is shown. As shown in FIG. 1, the intelligent search appliance 100 includes a client device 120, a server device 150, an operator or user or viewer of the client device. The operator uses the client device 120 and browser application 130 to access a server device by typing the address of the server device into the browser input. The browser communicates the query request to the server device across the network 140. The search component 170 on the server device analyzes the query terms, searches through an index sends back relevant results to be rendered on the browser. In an embodiment, HTML content and program code is returned by the server device 150. In other embodiments XML or JSON objects maybe returned back by the server device. The server device may use an object converter to convert objects from base language to XML or program code objects like JSON. The In an embodiment, the index maybe the intelligent index. In other embodiments, the search component may use other indexes, or may send across the requests to other search engines to return relevant results.

FIG. 2, FIG. 3, FIG. 4 show outputs from the ranking query algorithm for different query terms. The index had about 12 documents to show the scoring for the returned results. The query in Example 1, query B C D was changed to Bbbb Cccc Dddd 203 so that it could be searched through the index using the RankingAlgorithm. The results returned from the query are shown in FIG. 2. 201 shows the score and 202 shows the matching document, which is the same as used in Example 1. FIG. 3, shows the output for the query terms A B C D as in Example 2. 301 shows the score while 302 shows the matching document. 305 shows the query terms which have been changed to Aaaa Bbbb Cccc Dddd. FIG. 3 also shows the output for query terms and the scoring as in Example 3. 303 shows the score while 304 shows the matching document. The query terms are the same as in Example 2 changed to as in 305. FIG. 4 shows the output for query terms D A B C as in Example 4. 401 shows the score while 402 shows the matching document. 405 shows the query terms which have been changed to Dddd Aaaa Bbbb Cccc. FIG. 4 also shows the output for query terms as in Example 5. 403 shows the score while 404 shows the matching document. The query terms are as in 405.

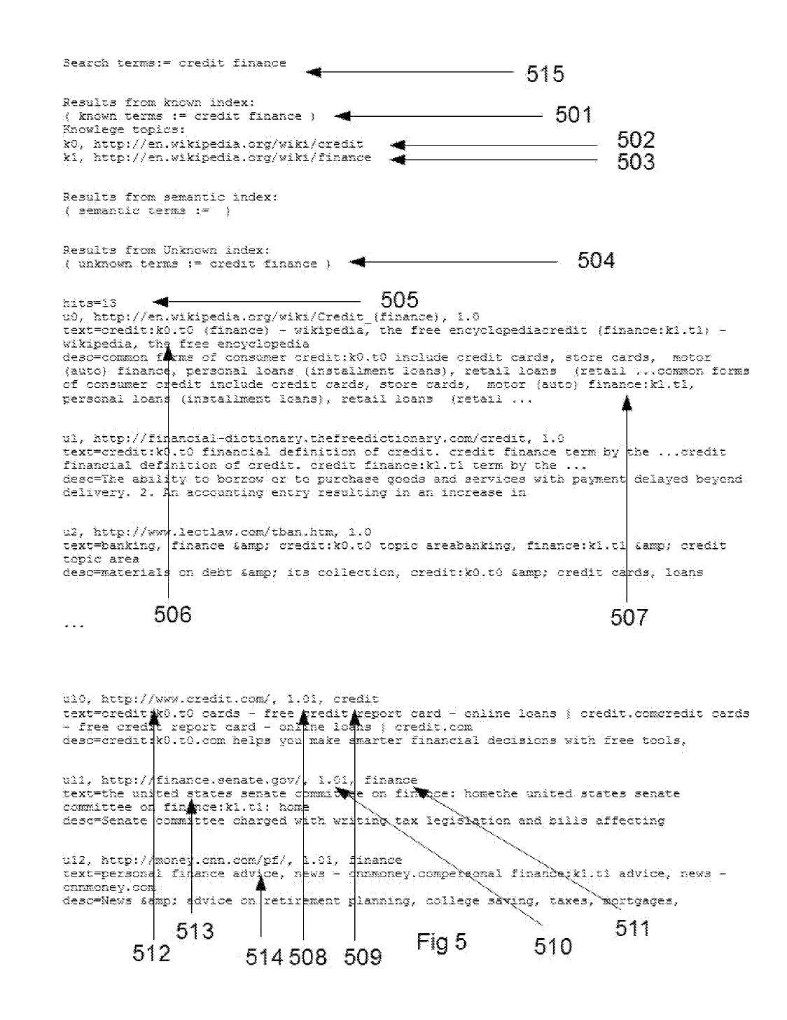

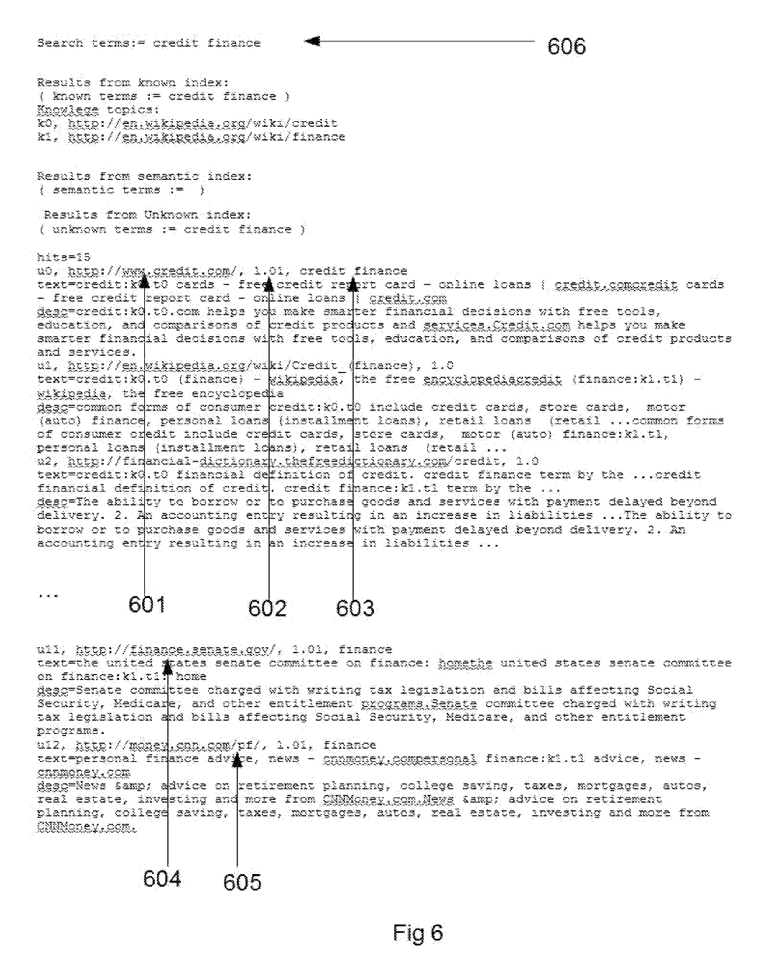

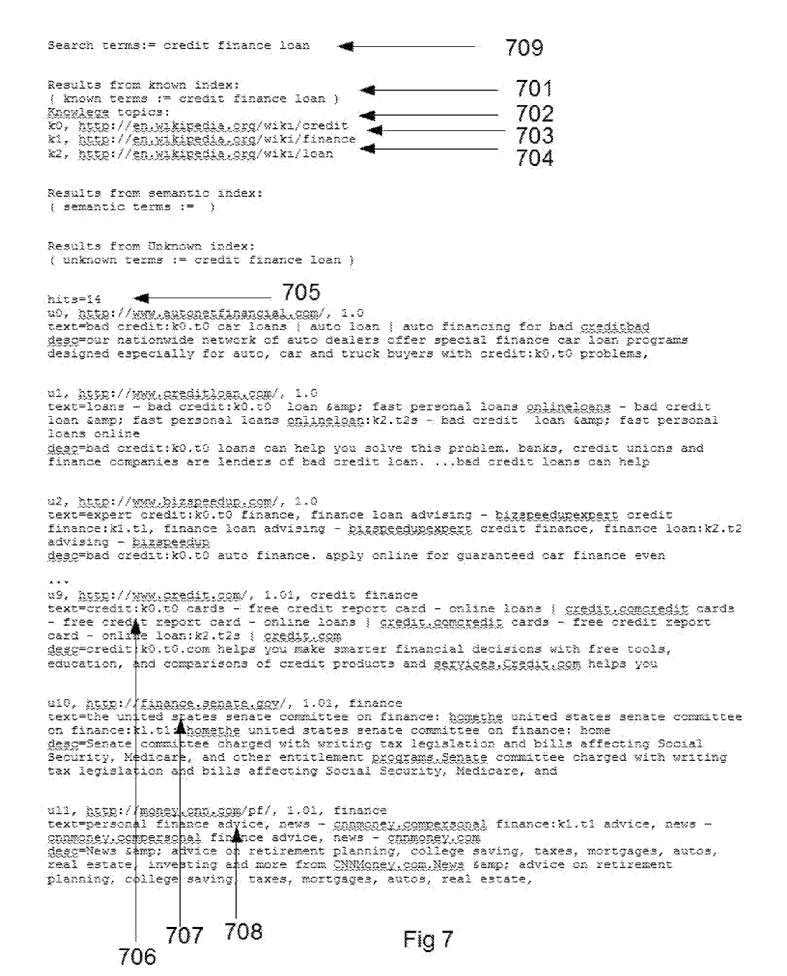

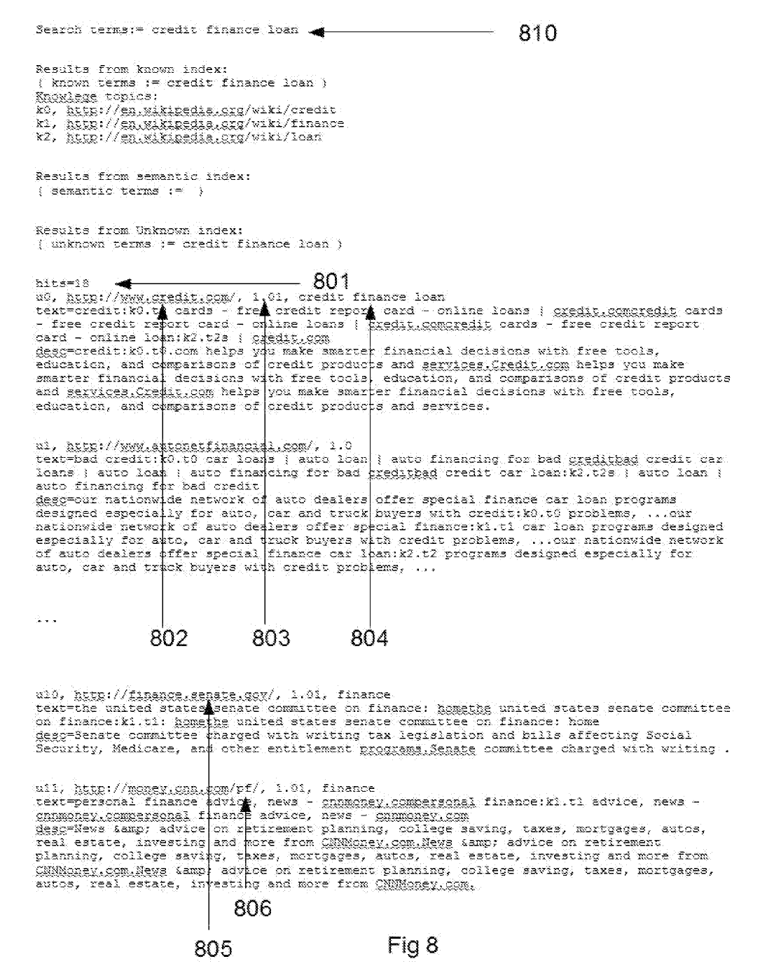

FIG. 5, FIG. 6, FIG. 7, FIG. 8 show the intelligent index learning new contexts and associating relationships between contexts. FIG. 5 shows relevant results from the known, semantic and unknown index for the query term “credit financing” 515. The results for the unknown index also include feedback results for “credit” and “finance” contexts. This was achieved by first searching for the term “credit”, providing input feedback on the link as in 512. Next a search was made by searching for the term “finance” and providing input feedback on the link as in 513. 501 shows the known terms as seen by the known index. The known index uses a sense tagger to tag the terms first and the output of the tagger are then analyzed to maybe throw away adjectives, etc. The remaining terms which may have been compounded by the tagger is looked up in the index or in a knowledgebase such as the wikipedia to see if the terms exist as a title topic in an embodiment. If the terms exist and if there is guiding info for the topic then the output is listed under the index. 502 shows that credit is a known term and along with the associated knowledge topic. 503 is again a known term and is listed along with the associated knowledge topic. In this embodiment the semantic index has not been made use of, so nothing is listed next to it. 504 shows the terms through the Unknown index. The Unknown index index in this embodiment has used an external search engine to retrieve the results and the results are shown next to it. 505 is the number of hits including the feedback results 512, 513, 514 from the index. 506 shows the indicator added by the intelligent index as feedback to the user that it knows the terms “credit”. In this embodiment, the indicators are k0.t0, meaning look at the Known index listing k0 for more information about the term, while t0 means look at tab0 for the search results for the topic, “credit”. The search is done in parallel in an embodiment but could be done when the user clicks on the tab or moves towards the tab or in the background using XmlHttpRequest or xsocket-http in other embodiments. In an other embodiment, guiding info tab and guide selections can be used to associate input with knowledge. 507 shows the indicator k1.t1 for the term “finance”. Again k1 meaning look in the Known index for listing k1 and tab1 for the more information on the topic, “finance”. 508 is the weight and 509 is the context associated with the link. 510 and 511 again show the weight and the context of a second link.

FIG. 6 shows the search again for the terms “credit financing” made by the same user or another user after the user in FIG. 5 has clicked on the link as shown in 512. The input click on link 512 adds the feedback into memory while storing the context “credit financing” as a child of the parent context “credit”. The other known term “financing” in the query terms is also stored in memory as related to the context “credit finance” with “credit” as the parent context. 606 shows the query terms used for this search which is the same as in FIG. 5 i.e. “credit financing”. 601 shows the new ranking for the link which is the same as in 512 but showing association with the context “credit financing” 603. 602 shows the weight of the link. 604 and 605 are the same as in 513 and 514 and are ranked lower.

FIG. 7 shows the search results for the query terms “credit financing loans” made by the same user as in FIG. 6 or another user. 709 shows the query terms used for the search. 701 is the known terms and 702, 703, 704 show the known topics. 705 shows the hits for the unknown index. 706 shows the link as in 601 and 512 but ranked lower. 707 and 708 are the same as 604 and 605 and ranked still lower than 706. The user selects and inputs a click on 706 as it is the most relevant result to view more information about the search. The unknown index stores the feedback input click by storing it in memory while incrementing its weight. The context “credit financing loans” is stored in memory with “credit” as the parent context. The sub contexts, “financing” and “loans” are also stored in memory as related to “credit financing loans” context, and “credit” as the parent context.

FIG. 8 shows the search results for the same user as in FIG. 7 or another user for the query terms as in 709. 810 shows the query terms while 801 shows the hits in the unknown index. 802 shows the link as in 706, 601, 512 but now ranked at the top. 803 shows the weight and 804 shows the new context, “credit finance loans”. 805 and 806 are the same as in 513 and 514 but ranked lower.

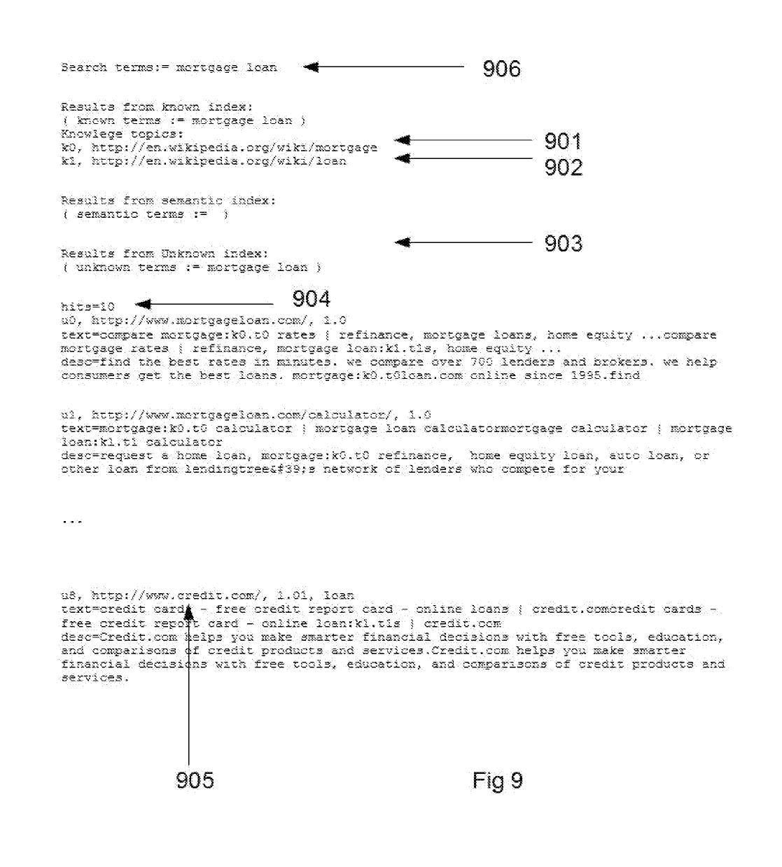

FIG. 9 shows the search results for the same user as in FIG. 9 or another user for the query terms as in 906. 901 shows the known terms and 902 and 903 show the known topics. 904 shows the number of hits in the unknown index and 905 shows the link with feedback as in 706 ranked lower with the context “loan”. The 706 link was added with “loan” as a sub context related to “credit financing” and “credit” as the parent context. The search for “mortgage loans” is now triggering the link to be associated with loans. If the user selects and inputs feedback by clicking on it, then the context “mortgage loans” is associated with the parent “credit” storing it in memory. The sub context “mortgage” is also added to memory as related to “mortgage loans” and parent “credit”. The weight is incremented for all the involved contexts, “loans”, “mortgage loans” and “mortgage”.

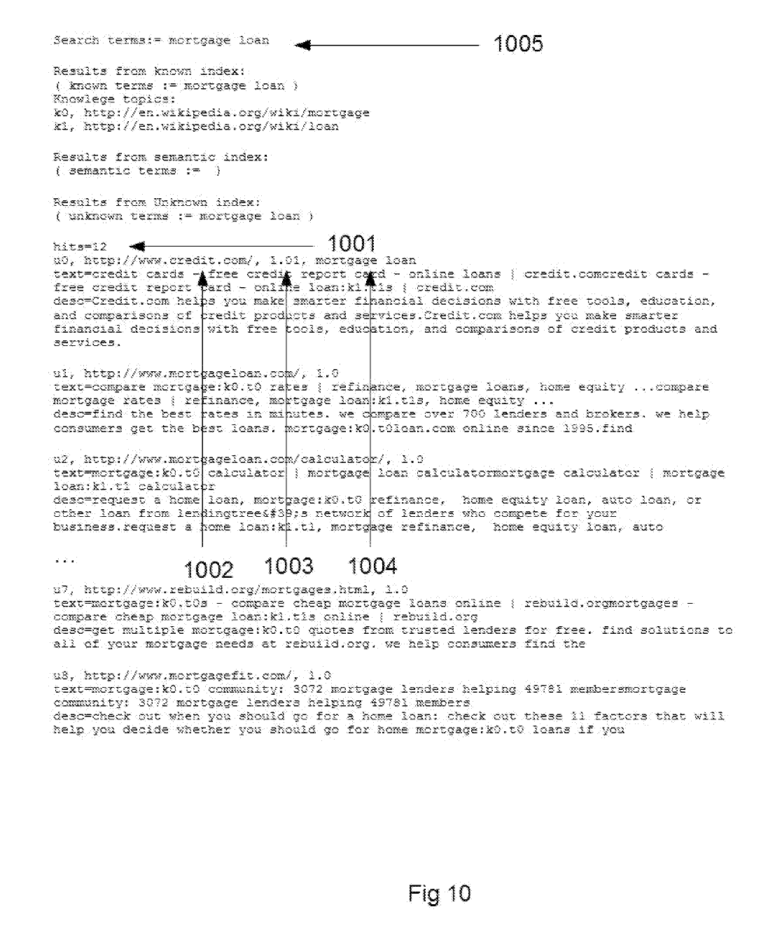

FIG. 10 shows the search results query terms as in 906, made by the same user or another user. 1005 shows the query terms, 1001 shows the hits in the unknown index and 1002 shows the link as in 905 now ranked at the top with feedback as in 1003 and the context as in 1004 “mortgage loan”.

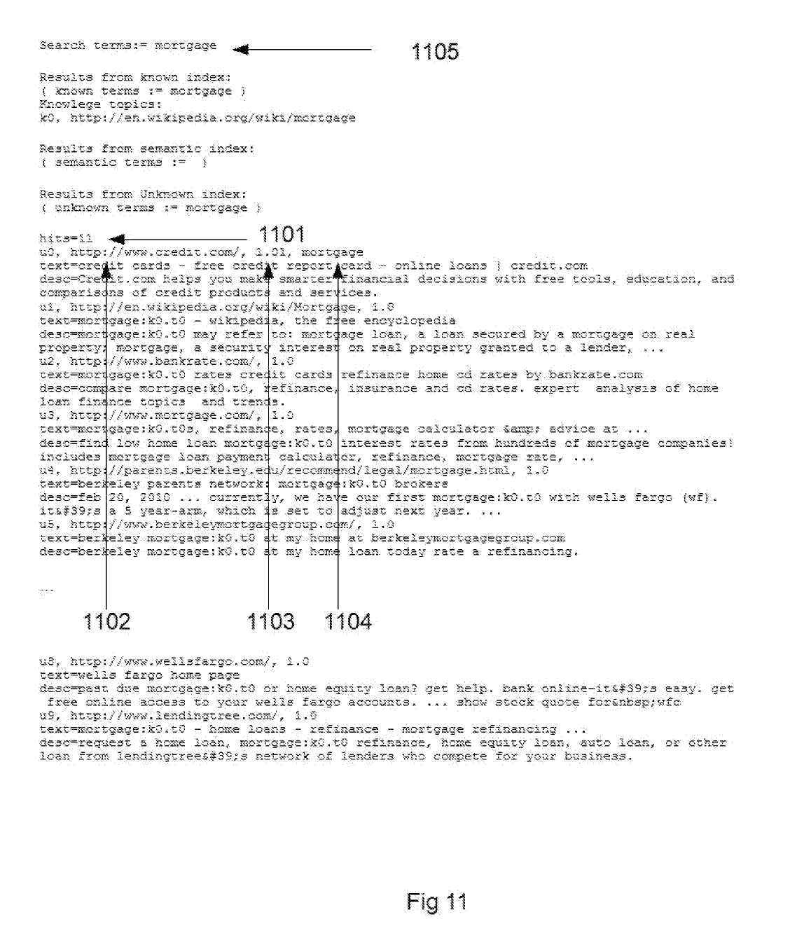

FIG. 11 shows the search results for query term “mortgage”, made by the same user or another user. 1105 shows the query terms, 1101 shows the hits in the unknown index and 1102 shows the link as in 905 now ranked at the top with feedback as in 1103 and the context as in 1104 “mortgage”. The intelligent index is learning the associations and relations between the original link with context “credit” and the terms “mortgage”, “credit”, “loans” and “mortgage loans” enabling it to rank the link as a related and relevant using the feedback from the users.

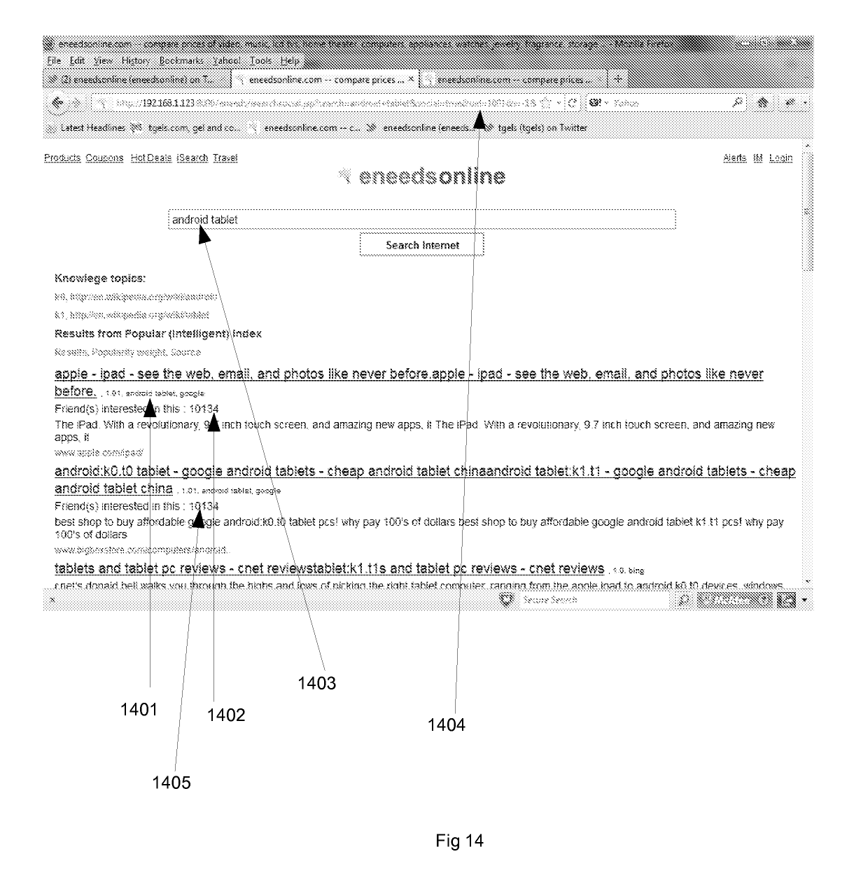

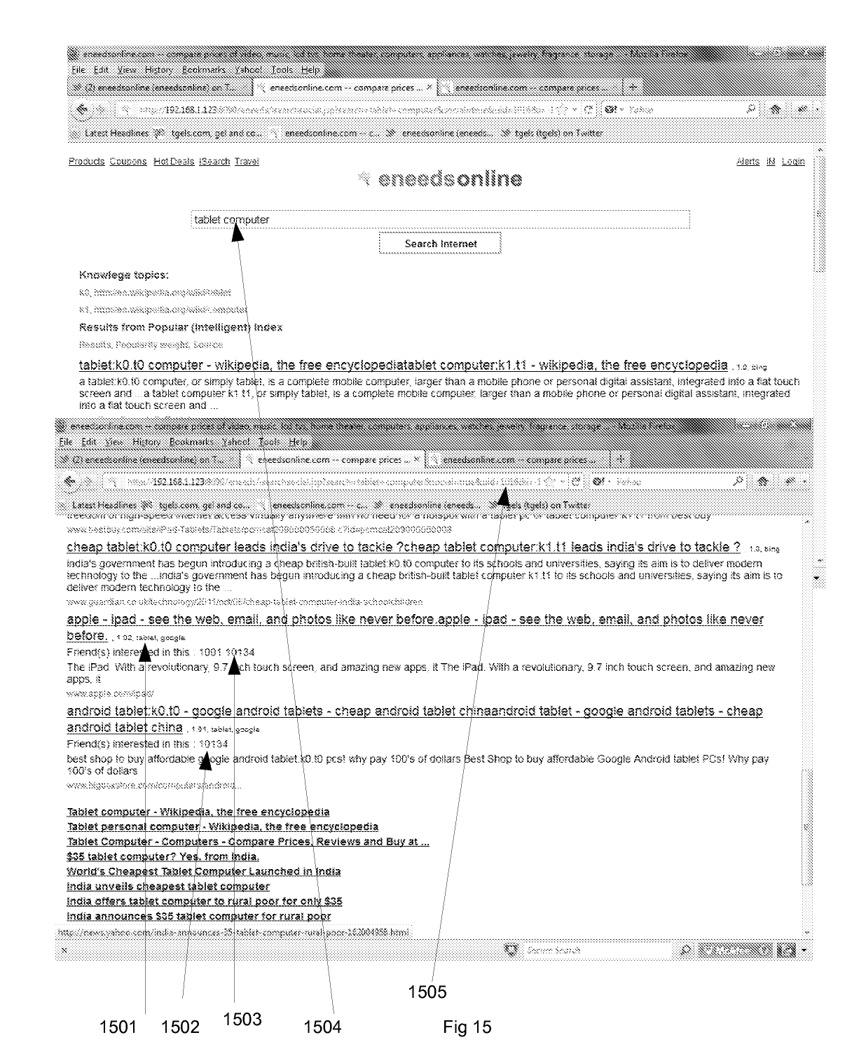

FIG. 14 shows the search result for the query terms “android tablet” made by uid:1001. 1403 shows the query terms, 1402 shows that friend with uid:10134 is interested in an ipad tablet, the link shows up at the top due to the feedback weightage available from a previous search made by uid:10134 for an ipad tablet and having provided input feedback by clicking on the link. uid:10134 also searched for an android tablet and had provided feedback by clicking on a link and is shown in 1405. 1401 shows the current context of the search, any feedback by clicking on the link will associate that android is a tablet and is related to ipad as a tablet. 1404 shows the uid of the user making the search. FIG. 15 shows the search results for the query terms “tablet computer” made by another uid:1016. Since uid:10134 and uid:1001 are part of the social graph of uid:1016, the ipad tablet computer search results are pulled up with context tablet matching the query 1501 and shows that friends uid:10134 and uid:1001 are interested in an ipad tablet, 1503. 1502 shows that friend uid:10134 is also interested in an android tablet. 1504 shows the query terms and 1505 shows the user id of the user making the search. In this embodiment, the social influence information is shown mixed with the search results but the social influence results can be shown in a different tab. If a user makes a purchase and if that information is available, that can be added to the search results to further influence the social graph. Sentiments can also be added as indicators to maximize the influence.

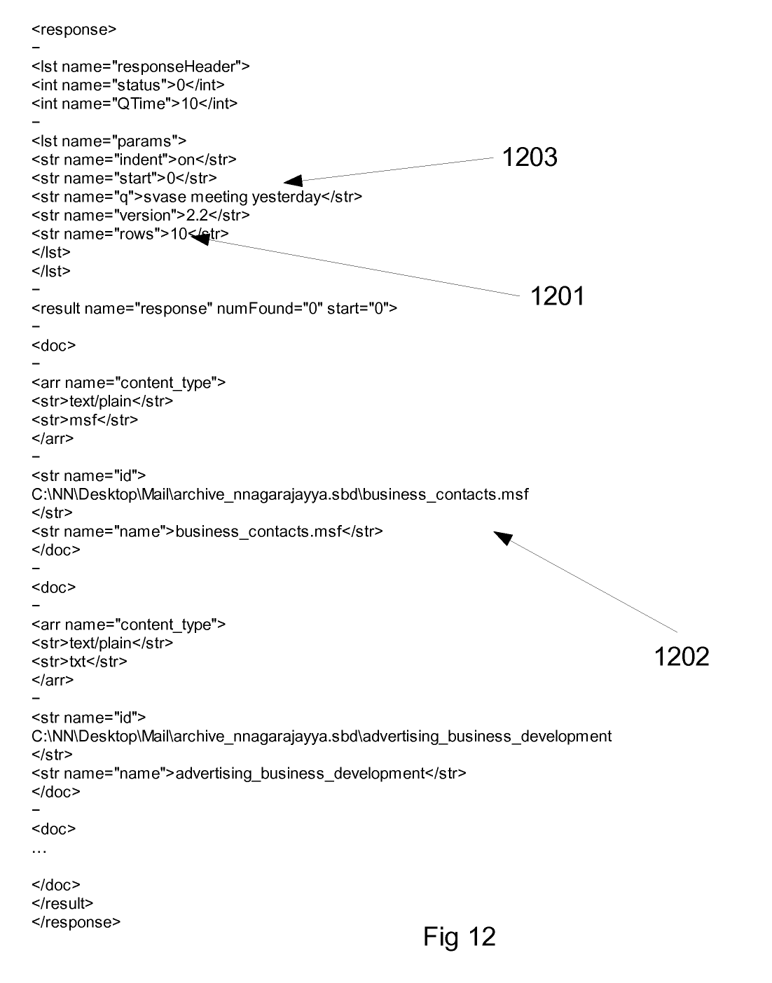

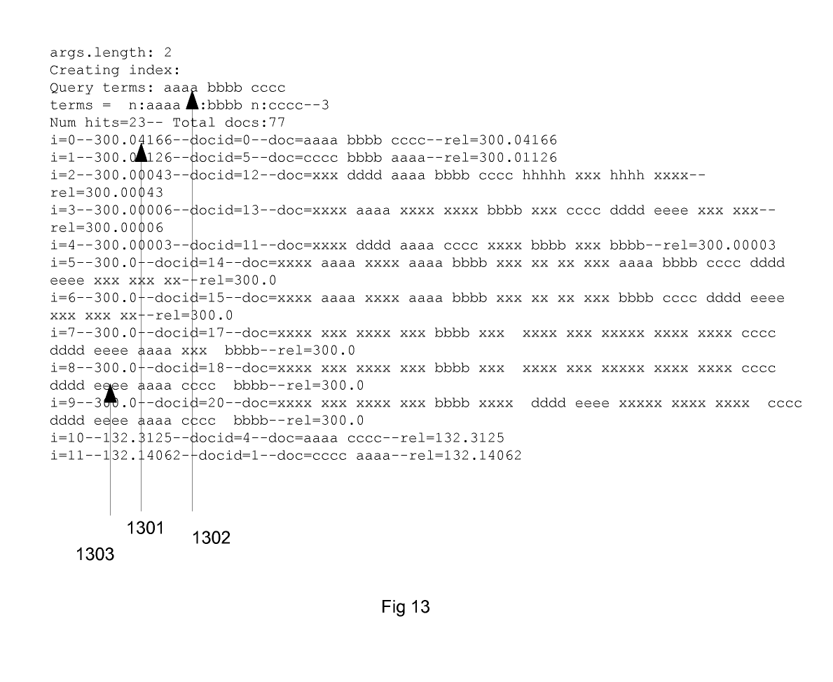

FIG. 12 shows the output from a server device where in the search component 107 is SoIr, an open source search platform. The default Lucene search and scoring mechanism in SoIr has been replaced by the new RankingAlgorithm enabling SoIr to make use of the ranking algorithm as described in [Para 30]. RankingAlgorithm is an implementation of the ranking algorithm as shown in FIG. 2, FIG. 3 and FIG. 4. 1203 shows the query terms, 1201 shows the number of hits and 1202 shows one of the documents ranked at the top. The documents indexed are email documents, indexed using SoIr. In this embodiment, the RankingAlgorithm has been integrated with SoIr but in other embodiments it could be integrated with other search platforms.

Although the present invention has been described with respect to a preferred embodiment thereof, those skilled in the art will note that various substitutions may be made to those embodiments described herein without departing from the spirit and scope of the present invention. Object attributes, program code, and functions specified and described herein have been selected for clarity of exposition, and do not represent all possible transformations or combinations. Those skilled in the art will also note that although embodiments of the present invention have been described in the context of Ranking algorithm, Intelligent search, Feedback, Memory, Social Awareness [etc.] certain features or embodiments may also apply to other forms of search not shown or discussed.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| URL | Uniform Resource Locator |
| XML | Extensible Markup Language |
| TCP | Transmission Control Protocol |
| IP | Internet Protocol |
| Java | An object oriented programming language |
| Web | World wide web, www, also known as the |
| | internet |
| Browser | A Graphical User Interface for viewing |
| | content called html on the web |
| Ajax | A technology to dynamically refresh content |
| | onto a browser client |

What is claimed is:

1. A method for searching in a computer based system comprising: (a) a client device code (b) a server device (c) intelligent index
whereby the server device responds to requests from client device using the said intelligent index with memory and feedback means to search, rank and return back relevant results with and without feedback indicators.

2. The method of claim 1 further comprising, making use of the ranking algorithm means to score and rank documents.

3. The method of claim 1 further comprising said intelligent index using feedback and memory to associate context relationships; said relationships enable a related context to be retrieved from memory and ranked relevantly.

4. The method of claim 1 further comprising said intelligent index using feedback and memory to associate search results with social awareness; said social awareness enables social information to be included as indicators in said results.

5. A method for searching on internet or intranet in a computer based system comprising the steps of: receiving a query; generating a list of hits related to the query where each hit is a document that has at least one of the terms in the query;
calculating a score for each document in the list of hits; (a) if terms are found next to each other in said document, assigning a high score measure A; (b) if terms are found closer to the start of the said document assigning a high score measure A; (c) if the terms are located across the document but with other terms in between assigning a score measure B which is lower than said score measure A; (d) if the distance between the terms is greater than the number of query terms assigning a score measure C which is lower than said score measure B; (e) assigning a score measure C if terms are located next to each other but terms are reversed in occurrence; (f) if the terms are located across the document but mixed in occurrence they get a score measure D which is lower than score measure C; (g) calculating a measure T based on the number of query terms matching in the said document; (h) if the terms repeat incrementing a frequency measure F; (i) if the terms occur in the same order or mixed or reversed incrementing a frequency occurrence count measure FC; associating score measures in steps (a)-(i) to form a single score measure that can be used to rank the said documents relevantly as a list of hits so as to return the hits as response to the said query.

6. The method of claim 5 wherein said steps (a)-(i) can be executed without dependency on the order of steps; skipping the steps as needed to get a score measure that can be used to rank the said list of hits.

7. The method of claim 5 further comprising, making use of the intelligent index with feedback and memory to the rank and weight documents.

8. The method of claim 5 further comprising using said intelligent index and feedback and memory to associate context relationships; said relationships enable a related context to be retrieved from memory.

9. The method of claim 5 further comprising said intelligent index using feedback and memory to associate search results with social awareness; said social awareness enables social information to be included as indicators in said results.

10. The method of claims 1 and 5, wherein said client device maybe a general purpose computer; said client device executes a client application that can connect to a server device across a network; said client application can render content and execute program code sent back by server device.
